(19) United States
(12) Patent Application Publication
(10) Pub. No.: US 2009/0096738 A1
(43) Pub. Date: Apr. 16, 2009

(54) DRIVING CIRCUIT CAPABLE OF SIMULTANEOUSLY DRIVING THREE-COLOR BISTABLE LIQUID CRYSTALS

(76) Inventors: Chih-Jen CHEN, Hsin Chu Hsien (TW); Chih-Wen HSIAO, Hsin Chu Hsien (TW); Tai-Ann CHEN, Hsin Chu Hsien (TW)

Correspondence Address: BIRCH STEWART KOLASCH & BIRCH, PO BOX 747, FALLS CHURCH, VA, 22040-0747, US

(21) Appl. No.: 12/189,994

(22) Filed: Aug. 12, 2008

(30) Foreign Application Priority Data
Oct. 12, 2007 (TW) 96138129

(51) Int. Cl. G09G 3/36

(52) U.S. Cl. 345/98

(57) ABSTRACT

This invention provides a driving circuit for simultaneously driving three-color bistable liquid crystals, which employs a voltage-shift circuit to provide different-color bistable liquid crystals with respective level-shift voltages. A grey-scale voltage is respectively added to the respective level-shift voltages. By this invention, the whole grey-scale voltages are capable of falling in the voltage ranges for displaying grey scales for the different-color bistable liquid crystals. The grey-scale display can be optimized.

### BACKGROUND OF THE INVENTION

1. Field of the Invention

The present invention relates to a driving circuit for simultaneously driving three color bistable liquid crystals, and more particularly to a driving circuit provided with level-shift voltage function for simultaneously driving three color bistable liquid crystals.

2. Description of the Related Art

Cholesterol liquid crystals are a bistable liquid crystal material. The cholesterol liquid crystals would have different optical transparences as the voltages applied to them are different. When the applied voltage is removed, the cholesterol liquid crystals are kept at the present state and would not return to the original state, which hence provides the advantage of saving power. FIG. 1 is a schematic diagram of a conventional passive matrix three color cholesterol liquid crystal display device, including a display area 100, a scan voltage driving circuit 101 and a data voltage driving circuit 102. The display area 200 includes a plurality of red, green and blue cholesterol liquid crystals 100R, 100G and 100B. The scan voltage driving circuit 101 and the data voltage driving circuit 102 respectively provide voltages to the upper and lower electrode terminals of the corresponding liquid crystal cells via scan lines and data lines. The scan voltage driving circuit 101 outputs a fixed voltage as a scan voltage to sequentially scan each row of the liquid crystal cells. The data voltage driving circuit outputs the voltages required for gray-scale display. The difference between the output voltage of the scan voltage driving circuit 101 and the output voltage of the data voltage driving circuit 102 is an electrical potential across the two electrode terminals of each of the liquid crystal cells, namely a gray-scale voltage. FIG. 2 is characteristic transfer curves of the reflectance of the cholesterol liquid crystals vs. liquid crystal driving voltages. It is seen from FIG. 2 that the driving voltage sections of different color cholesterol liquid crystals for gray-scale display are different. For example, the driving voltage section of the red cholesterol liquid crystals for gray-scale display is 21-29 volts, the driving voltage section of the green cholesterol liquid crystals for gray-scale display is 23-31 volts, and the driving voltage section of the blue cholesterol liquid crystals for gray-scale display is 28-36 volts. For the conventional driving scheme for the passive matrix cholesterol liquid crystal display device, as shown in Table I of FIG. 3, in case that the blue cholesterol liquid crystals are used as a baseline, the fixed voltage (scan voltage) outputted from the scan voltage driving circuit 101 is 36 volts in order that all the gray-scale images of the red, green and blue cholesterol liquid crystal cells 100R, 100G and 100B can be displayed, the data voltage driving circuit 102 needs to output data voltage in the range of 0-15 volts. As a consequence, according to the characteristic transfer curves of FIG. 2, the red cholesterol liquid crystals 100R could not display gray-scale images in the range of 36 to 29 volts, the green cholesterol liquid crystals 100G could not display gray-scale images in the ranges of 23 to 21 volts and 36 to 31 volts, and the blue cholesterol liquid crystals 100B could not display gray-scale images in the range of 28 to 21 volts. This conventional liquid crystal display device structure and its conventional driving scheme would have a result that each kind of the cholesterol liquid crystals has its own driving voltage section incapable of gray-scale display. The gray-scale display could not be optimized. Hence, there is a situation that certain colors of the liquid crystal display device can not be normally displayed.

### SUMMARY OF THE INVENTION

This invention provides a voltage-shift circuit used for providing respective level-shift voltages to different color bistable liquid crystal cells, and being followed by adding a gray-scale data voltage to the respective level-shift voltages in order that all the gray-scale data voltages are fallen within the range capable of display for all the different color liquid crystal cells so as to optimize the gray-scale display.

This invention provides a driving circuit capable of simultaneously driving three-color bistable liquid crystals including a driving voltage input circuit and a voltage-shift circuit, in which the driving voltage input circuit receives an input voltage from the external so as to output a predetermined driving voltage and the voltage-shift circuit includes a plurality of sub-voltage-shift circuit, wherein the predetermined driving voltage and a predetermined level-shift voltage required by a liquid crystal cell are inputted to one of the sub-voltage-shift circuit corresponding thereto via the same input terminal or different input terminals of the sub-voltage-shift circuit, and the sub-voltage-shift circuit via an output terminal thereof outputs a liquid crystal driving voltage to an electrode terminal of the liquid crystal cell.

The driving circuit of the present invention can be employed as a data voltage driving circuit or a scan voltage driving circuit for a passive matrix three-color bistable liquid crystal display device. When the driving circuit is employed as the data voltage driving circuit of the passive matrix three-color bistable liquid crystal display device, data voltages are inputted via the driving voltage input circuit, and the respective level-shift voltages required by the different color bistable liquid crystal cells are inputted via the voltage-shift circuit, which also outputs respective voltages to the different color bistable liquid crystal cells for gray-scale display. When the driving circuit of the present invention is employed as the scan voltage driving circuit of the passive matrix three-color bistable liquid crystal display device, the scan voltages are inputted via the driving voltage input circuit, and the respective level-shift voltages required by the different bistable liquid crystal cells are inputted via the voltage-shift circuit, which also outputs the respective scan driving voltages to the different color bistable liquid crystal cells for gray-scale display.

Similarly, the driving circuit for simultaneously driving three-color bistable liquid crystals of the present invention also can be employed as a data voltage driving circuit of an active matrix three color bistable liquid crystal display device.

### BRIEF DESCRIPTION OF THE DRAWINGS

FIG. 1 is a schematic diagram of a conventional passive matrix three color cholesterol liquid crystal display device;

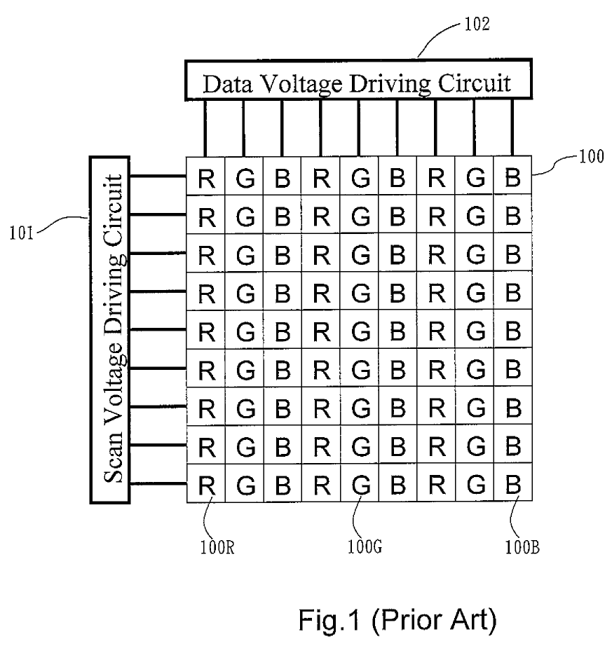

FIG. 2 is characteristic transfer curves of the reflectance of the cholesterol liquid crystals vs. liquid crystal driving voltages;

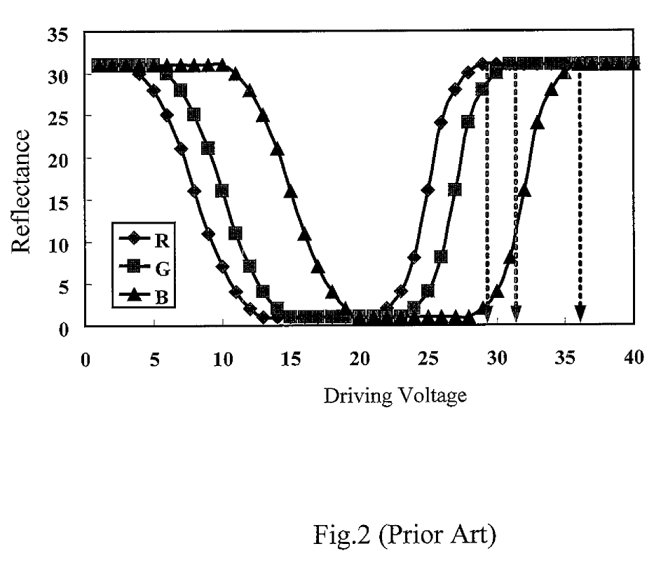

FIG. 3 is Table I, showing the scan voltages, data input voltage ranges, liquid crystal driving voltage ranges and unused gray-scale voltage ranges of the different color cholesterol liquid crystals when employing the conventional driving scheme;

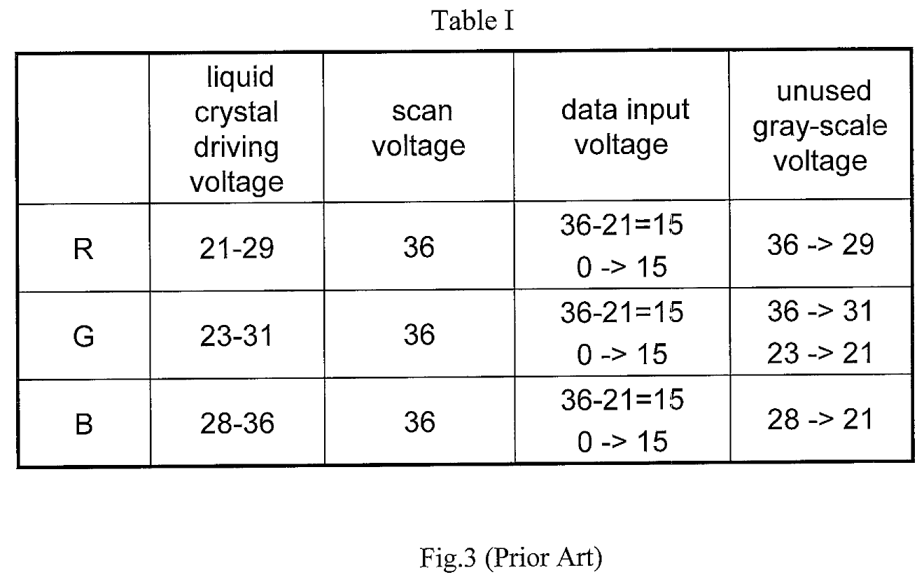

FIG. 4 is Table II, showing the scan voltages, data input voltage ranges, liquid crystal driving voltage ranges and unused gray-scale voltage ranges of the different color cholesterol liquid crystals when employing a driving scheme of the present invention;

FIG. 5 is a block diagram of a data voltage driving circuit with level-shift voltage of the present invention;

FIG. 6 is a schematic diagram of a passive matrix three color bistable liquid crystal display device;

FIG. 7A to FIG. 7D is variances of sub-voltage-shift circuits of the present invention;

FIG. 8 is a schematic diagram of another passive matrix three color bistable liquid crystal display device; and

FIG. 9 is a block diagram of a driving circuit capable of simultaneously driving three-color bistable liquid crystals of the present invention.

### DETAILED DESCRIPTION OF THE PREFERRED EMBODIMENTS

The present invention provides a driving circuit capable of simultaneously driving three-color bistable liquid crystals, which employs the voltage-shift scheme to compensate the driving voltage section incapable of gray-scale display in the conventional method for driving a bistable liquid crystal display device. Hence, the output voltages applied to the bistable liquid crystal display device of the present invention would not have the voltage section incapable of gray-scale display exist, and the gray-scale display is optimized. The output voltages also can be finely divided to increase the gray-scale numbers so as to maximize the gray-scale display.

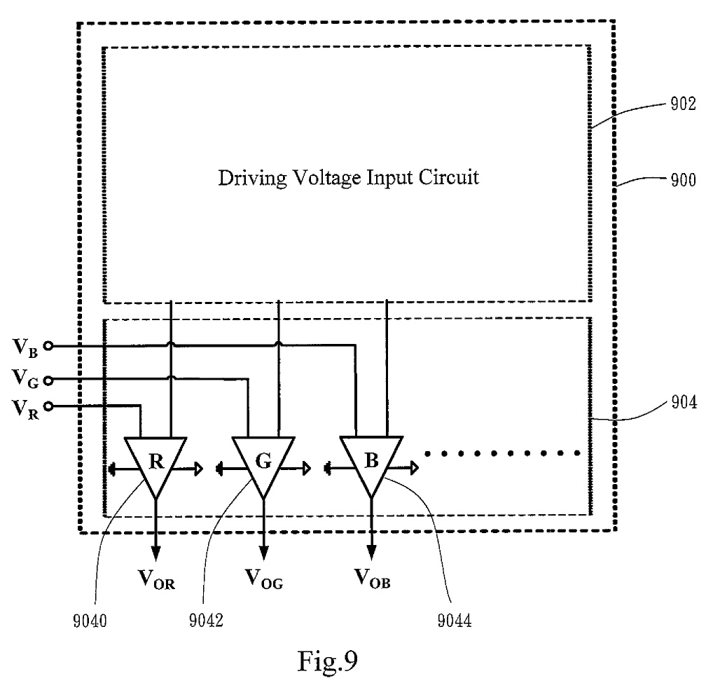

FIG. 9 is a schematic diagram of a driving circuit 900 capable of simultaneously driving three-color bistable liquid crystals of the present invention. The driving circuit 900 includes a driving voltage input circuit 902 and a voltage-shift circuit 904. The driving voltage input circuit 902 receives an input voltage from the external so as to output a predetermined driving voltage. The voltage-shift circuit 904 includes a plurality of sub-voltage-shift circuits 9040, 9042 and 9044 respectively corresponding to the red, green and blue bistable liquid crystal cells. Each of the sub-voltage-shift circuits 9040, 9042 and 9044 has two input terminals and an output terminal. One of the two input terminals of each of the sub-voltage-shift circuits 9040, 9042 and 9044 receives the predetermined driving voltage outputted from the driving voltage input circuit 902, and the other input terminals of the sub-voltage-shift circuits 9040, 9042 and 9044 receive respective predetermined level-shift voltages V_{R}, V_{G} and V_{B} required by the bistable liquid crystal cells corresponding thereto. The sub-voltage-shift circuits 9040, 9042 and 9044 output respective liquid crystal driving voltages V_{OR}, V_{OG} and V_{OB} via their output terminals to respective electrode terminals of the corresponding liquid crystal cells. When the driving circuit 900 capable of simultaneously driving three-color bistable liquid crystals is employed as a data voltage driving circuit, the data voltages are inputted into the driving voltage input circuit 902, while the predetermined level-shift voltages V_{R}, V_{G} and V_{B} required by the different color bistable liquid crystal cells are inputted via the respective sub-voltage-shift circuits 9040, 9042 and 9044. The sub-voltage-shift circuits 9040, 9042 and 9044 output the respective required voltages to the different color bistable liquid crystal cells for gray-scale display. As a consequence, even the present invention provides data voltages of the same voltage section to the different color bistable liquid crystal cells, the voltage-shift circuit 904 modulates the respective voltages required by the different color bistable liquid crystal cells for gray-scale display, the problem that the data voltages including the voltage section incapable of gray-scale display for the different bistable liquid crystal cells no longer exists. Similarly, when the driving circuit 900 capable of simultaneously driving three-color bistable liquid crystals is employed as a scan voltage driving circuit, the scan voltages are inputted into the driving voltage input circuit 902, while the respective predetermined level-shift voltages V_{R}, V_{G} and V_{B} required by the different bistable liquid crystal cells are inputted via the respective sub-voltage-shift circuits 9040, 9042 and 9044. The sub-voltage-shift circuits 9040, 9042 and 9044 provide the respective scan driving voltages required by the different color bistable liquid crystal cells for gray-scale display via their output terminals.

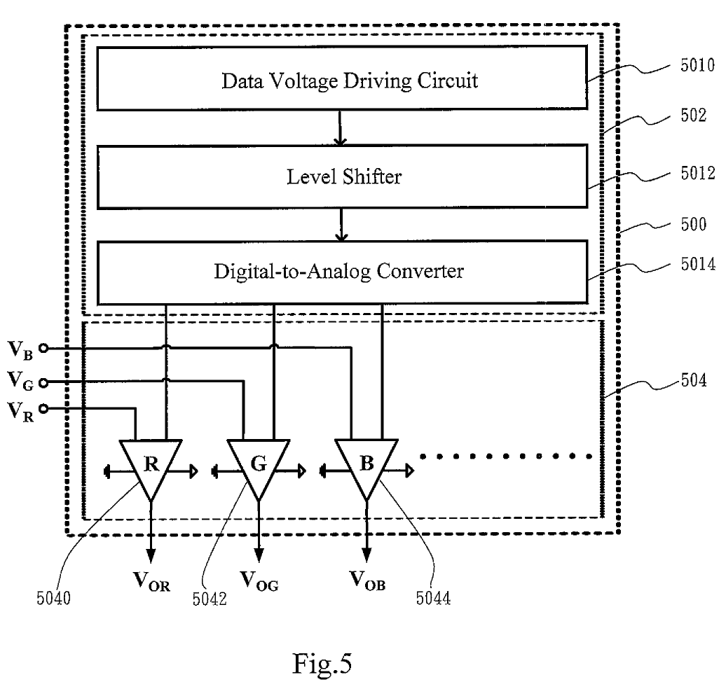

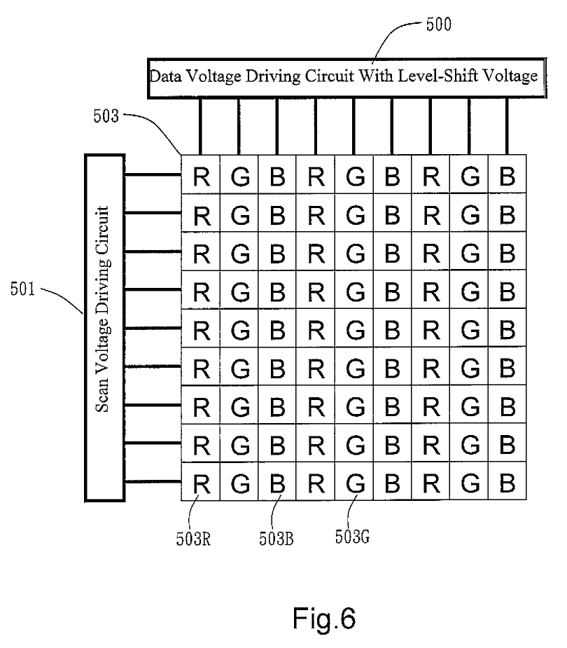

FIG. 5 is a schematic diagram of an application of the driving circuit capable of simultaneously driving three-color bistable liquid crystals of the present invention, which is employed as a data voltage driving circuit with level-shift voltage of a passive matrix three color bistable liquid crystal display device as shown in FIG. 6. Please refer to FIG. 6, the passive matrix three color bistable liquid crystal display device includes a data voltage driving circuit with level-shift voltage 500, a scan voltage driving circuit 501 and a display area 503. The display area 503 includes a plurality of columns of red bistable liquid crystal cells, a plurality of columns of blue bistable liquid crystal cells and a plurality of green bistable liquid crystal cells. Each column of the red bistable liquid crystal cells includes plural red bistable liquid crystal cells 503R aligned in the vertical direction (parallel with the scan direction), each column of the blue bistable liquid crystal cells includes plural blue bistable liquid crystal cells 503B aligned in the vertical direction, and each column of the green bistable liquid crystal cells includes plural green bistable liquid crystal cells 503G aligned in the vertical direction. The red bistable liquid crystal cells 503R, blue bistable liquid crystal cells 503B and the green bistable liquid crystal cells 503G are inter-disposed to each other in the parallel direction. The scan voltage driving circuit 501 includes a plurality of scan lines sequentially provides a fixed scan voltage to one row of the bistable liquid crystal cells 503R, 503G and 503R corresponding thereto. FIG. 5 shows the block diagram of the data voltage driving circuit 500, which includes a driving voltage input circuit 502 and a voltage-shift circuit 504. The driving voltage input circuit 502 includes a data voltage driving circuit 5010, a level shifter 5012 and a digital-to-analog converter 5014. An input voltage in the digital form corresponding to a gray-scale display is inputted into the data voltage driving circuit 5010 and then is shifted to a predetermined driving voltage in the digital form via the level shifter 5012. The predetermined driving voltage in the digital form is converted to an equal value in the analog form via the digital-to-analog converter 5014. The voltage-shift circuit 504 includes a plurality of sub-voltage-shift circuits 5040 for the red bistable liquid crystal cells, a plurality of sub-voltage-shift circuits 5042 for the green bistable liquid crystal cells and a plurality of sub-voltage-shift circuits 5044 for the blue bistable liquid crystal cells. Each of the sub-voltage-shift circuits 5040, 5042 and 5044 has two input terminals and one output terminal. One of the two input terminals of each of the sub-voltage-shift circuits 5040, 5042 and 5044 receives the predetermined driving voltage in the analog form, and the other input terminals of the sub-voltage-shift circuits 5040, 5042 and 5044 receive the respective predetermined level-shift voltages V_{R}, V_{G} and V_{B} required by the corresponding liquid crystal cells 503R, 503G and 503B. The respective liquid crystal driving voltages V_{OR}, V_{OG} and V_{OB} are outputted to the other electrode terminals of the corresponding liquid crystal cells 503R, 503G and 503B via the output terminals of the sub-voltage-shift circuits 5040, 5042 and 5044. The voltage differences between the liquid crystal driving voltage V_{OR} and the fixed scan voltage, between the liquid crystal driving voltage V_{OG} and the fixed scan voltage, and between the liquid crystal driving voltages V_{OB} and the fixed scan voltage, are the applied voltages for the corresponding liquid crystal cells 503R, 503G and 503B for gray-scale display.

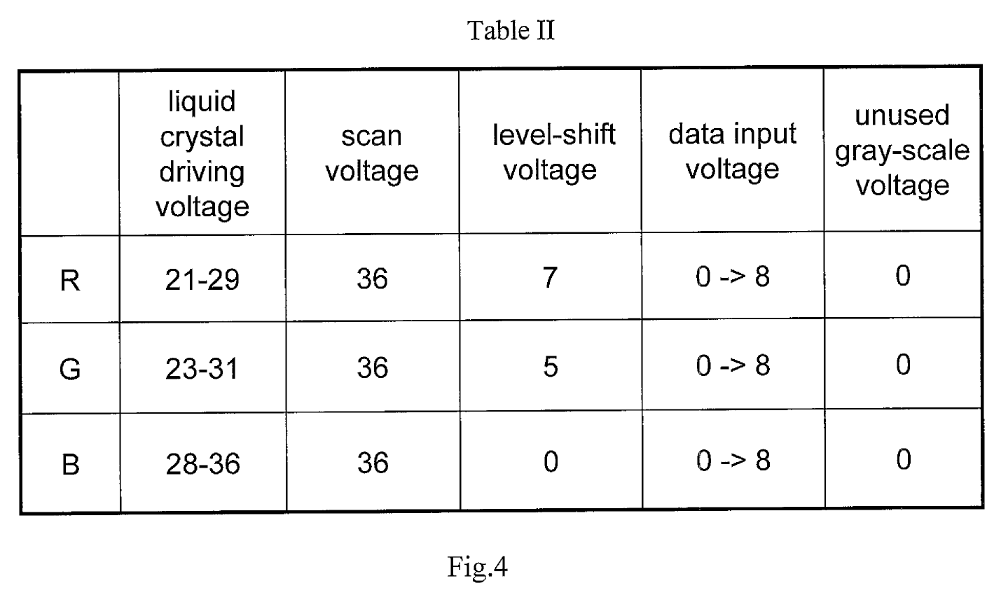

The principle of the driving circuit capable of simultaneously driving three-color bistable liquid crystals of the present invention is described in detail accompanying with Table II of FIG. 4 and by taking the passive matrix three color bistable liquid crystal display device shown in FIG. 6 as an example. The scan voltage driving circuit 501 outputs a fixed scan voltage 36 volts, while the respective sub-voltage-shift circuits 5040, 5042 and 5044 input the respective level-shift voltages V_{R}, V_{G} and V_{B} to the corresponding red, green and blue bistable liquid crystal cells. For example, the level-shift voltage of the red bistable liquid crystal cells 503R is 7 volts, the level-shift voltage of the green bistable liquid crystal cells 503G is 5 volts, and the level-shift voltage of the blue bistable liquid crystal cells 503B is 0 volt. In this case, the data voltage driving circuit 5010 within the data voltage driving circuit with level-shift voltage 500 receives the same data input voltage range of 0-8 volts for all the three color bistable liquid crystal cells 503R, 503G and 503B such that the liquid crystal driving voltages of the red bistable liquid crystal cells 503R for gray-scale display are fallen in the range of 21-29 volts capable of gray-scale display, the liquid crystal driving voltages of the green bistable liquid crystal cells 503G for gray-scale display are fallen in the range of 23-31 volts capable of gray-scale display, and the liquid crystal driving voltages of the blue bistable liquid crystal cells 503B for gray-scale display are fallen in the range of 28-36 volts capable of gray-scale display. As a consequence, although the red, green and blue bistable liquid crystal cells receive the same data input voltage range of 0-8 volts, the applied voltages of these bistable liquid crystal cells are shifted with the respective level-shift voltages, there is no applied voltage section incapable of gray-scale display for the red, green and blue bistable liquid crystal cells 503R, 503G and 503B exist. All the data input voltages can be used in gray-scale display for the three color bistable liquid crystal cells. In addition, the data input voltages can be finely divided to increase the gray-scale number to maximize the gray-scale display.

The above case employs the voltage driving scheme. A pulse width modulation method also utilizing the principle of level-shift voltage is employable in the present invention. The pulse width modulation method is implemented by using a fixed voltage but modulating the period of data write-in. The pulse width modulation method only has two kinds of input voltages of 0 and 8 volts, the level-shift voltages of the red, green and blue bistable liquid crystal cells 503R, 503G and 503B are maintained the same as Table II, while the data input voltages for gray-scale display with respect to the red, green and blue bistable liquid crystal cells 503R, 503G and 503B are controlled by the period of the data write-in.

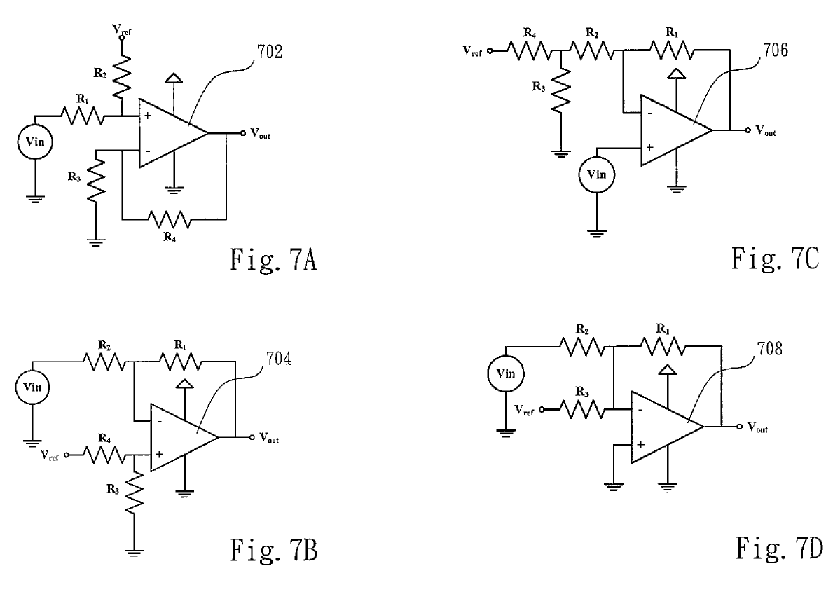

Referring to FIG. 9 again, each of the sub-voltage-shift circuits 9040, 9042 and 9044 of the driving circuit 900 capable of simultaneously driving three-color bistable liquid crystals has several variances. FIG. 7A to FIG. 7D shows the variances of the circuit design of the sub-voltage-shift circuits 9040, 9042 and 9044. Please refer to FIG. 7A, the sub-voltage-shift circuit 9040, 9042 or 9044 includes an operational amplifier 702, a first resistor R₁, a second resistor R₂, a third resistor R₃ and a fourth resistor R₄. An input terminal of the operational amplifier 702 is electrically coupled to one terminal of the first resistor R₁ and the second resistor R₂, and the other input terminal of the operational amplifier 702 is electrically coupled to one terminal of the third resistor R₃ and the fourth resistor R₄ as well as an output terminal of the operational amplifier 702 is electrically coupled to an electrode terminal of a corresponding bistable liquid crystal cell for data voltage input. The other terminal of the first resistor R₁ is electrically coupled to the predetermined driving voltage Vᵢₙ from the driving voltage input circuit 902. The other terminal of the second resistor R₂ is electrically coupled to the predetermined level-shift voltage V_{ref} of the bistable liquid crystal cell corresponding thereto. The other terminal of the third resistor R₃ is grounded. The other terminal of the fourth resistor R₄ is electrically coupled to the output terminal of the operational amplifier 702. According to the circuit design of FIG. 7A for the sub-voltage-shift circuit 9040, 9042 or 9044, the predetermined driving voltage Vᵢₙ and the predetermined level-shift voltage V_{ref} are inputted to the operational amplifier 702 via the same input terminal thereof. It is noted that the sub-voltage-shift circuits 9040, 9042 or 9044 have their respective Vref. The output voltage of the sub-voltage-shift circuit 9040, 9042 or 9044 is Vₒᵤₜ=Vᵢₙ+V_{ref}, and which is provided to the electrode terminal of the corresponding bistable liquid crystal cell for data voltage input.

Referring to FIG. 7B, the sub-voltage-shift circuit 9040, 9042 or 9044 includes an operational amplifier 704, a first resistor R₁, a second resistor R₂, a third resistor R₃ and a fourth resistor R₄. One input terminal of the operational amplifier 704 is electrically coupled to one terminal of the first resistor R₁ and the second resistor R₂. The other input terminal of the operational amplifier 704 is electrically coupled to one terminal of the third resistor R₃ and the fourth resistor R₄. The output terminal of the operational amplifier 704 is electrically coupled to an electrode terminal of a corresponding bistable liquid crystal cell for data voltage input. The other terminal of the first resistor R₁ is electrically coupled to the output terminal of the operational amplifier 704. The other terminal of the second resistor R₂ is electrically coupled to the predetermined driving voltage Vᵢₙ from the driving voltage input circuit 902. The other terminal of the third resistor R₃ is grounded. The other terminal of the fourth resistor R₄ is electrically coupled to the predetermined level-shift voltage V_{ref} of the corresponding bistable liquid crystal cells. It is noted that the sub-voltage-shift circuits 9040, 9042 or 9044 have their respective Vref. According to the circuit design of FIG. 7B for the sub-voltage-shift-circuit 9040, 9042 or 9044, the output voltage of the sub-voltage-shift circuit 9040, 9042 or 9044 is Vₒᵤₜ=−Vᵢₙ+V_{ref}, which is provided to the electrode terminal of the corresponding bistable liquid crystal cell for data voltage input.

Referring to FIG. 7C, the sub-voltage-shift circuit 9040, 9042 or 9044 includes an operational amplifier 706, a first resistor R₁, a second resistor R₂, a third resistor R₃ and a fourth resistor R₄. One input terminal of the operational amplifier 706 is electrically coupled to the predetermined driving voltage Vᵢₙ from the driving voltage input circuit 902. The other input terminal of the operational amplifier 706 is electrically coupled to one terminal of the first resistor R₁ and the second resistor R₂, An output terminal of the operational amplifier 706 is electrically coupled to an electrode terminal of the corresponding bistable liquid crystal cell for data voltage input. The other terminal of the first resistor R₁ is electrically coupled to the output terminal of the operational amplifier 706. The other terminal of the second resistor R₂ is electrically coupled to one terminal of the third resistor R₃ and the fourth resistor R₄. The other terminal of the third resistor R₃ is grounded. The other terminal of the fourth resistor R₄ is electrically coupled to the predetermined level-shift voltage V_{ref} of the corresponding bistable liquid crystal cell. It is noted that the sub-voltage-shift circuits 9040, 9042 or 9044 have their respective Vref. According to the circuit design of FIG. 7C for the sub-voltage-shift circuit 9040, 9042 or 9044, the output voltage of the sub-voltage-shift circuit 9040, 9042 or 9044 is Vₒᵤₜ=Vᵢₙ−V_{ref}, which is provided to the electrode terminal of the corresponding bistable liquid crystal cell for data voltage input.

Referring to FIG. 7D, the sub-voltage-shift circuit 9040, 9042 or 9044 includes an operational amplifier 708, a first resistor R₁, a second resistor R₂ and a third resistor R₃. One input terminal of the operational amplifier 708 is electrically coupled to one terminal of the first resistor R₁, the second resistor R₂ and the third resistor R₃. The other input terminal of the operational amplifier 708 is grounded. An output terminal of the operational amplifier 708 is electrically coupled to an electrode terminal of a corresponding bistable liquid crystal cell for data voltage input. The other terminal of the first resistor R₁ is electrically coupled to the output terminal of the operational amplifier 708. The other terminal of the second resistor R₂ is electrically coupled to the predetermined driving voltage Vᵢₙ from the driving voltage input circuit 902. The other terminal of the third resistor R₃ is electrically coupled to the predetermined level-shift voltage V_{ref} of the corresponding bistable liquid crystal cell. It is noted that the sub-voltage-shift circuits 9040, 9042 or 9044 have their respective Vref. According to the circuit design of FIG. 7D for the sub-voltage-shift circuit 9040, 9042 or 9044, the predetermined driving voltage Vᵢₙ and the predetermined level-shift voltage V_{ref} are inputted to the operational amplifier 708 via the same input terminal, the output voltage of the sub-voltage-shift circuit 9040, 9042 or 9044 is Vₒᵤₜ=−Vᵢₙ−V_{ref}, which is provided to the electrode terminal of the corresponding bistable liquid crystal cell for data voltage input.

The present invention depends on the polarity of the data input voltage and the increment or decrement of the level-shift voltage to choose an appropriate one of the sub-voltage-shift circuits of FIG. 7A to FIG. 7D applicable in the voltage-shift circuit 904.

The data voltage driving circuit with level-shift voltage 500 of FIG. 5 is applicable in an active matrix three color bistable liquid crystal display device.

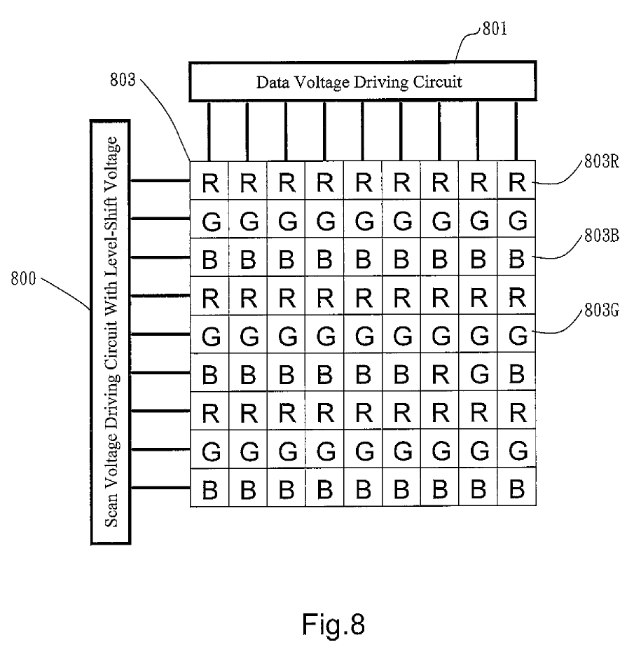

In addition, the driving circuit 900 capable of simultaneously driving three-color bistable liquid crystals of FIG. 9 also can be employed as a scan voltage driving circuit with level-shift voltage of a passive matrix bistable liquid crystal display device. FIG. 8 is a schematic diagram of the passive matrix bistable liquid crystal display device, which includes a scan voltage driving circuit with level-shift voltage 800, a data voltage driving circuit 801 and a display area 803. The display area 803 includes a plurality of rows of red bistable liquid crystal cells aligned in the parallel direction, a plurality of rows of green bistable liquid crystal cells aligned in the parallel direction, and a plurality of rows of blue bistable liquid crystal cells aligned in the parallel direction. Each row of the red bistable liquid crystal cells includes a plurality of red bistable liquid crystal cells 803R, each row of the green bistable liquid crystal cells includes a plurality of green bistable liquid crystal cells 803G, and each row of the blue bistable liquid crystal cells includes a plurality of blue bistable liquid crystal cells 803B. The red, green and blue bistable liquid crystal cells 803R, 803G and 803B are inter-disposed in the vertical direction (parallel with the scan direction). The scan voltage driving circuit with level-shift voltage 800 includes a plurality of scan lines sequentially provides a scan voltage to a row of the bistable liquid crystal cells corresponding thereto. The scan voltage driving circuit with level-shift voltage 800 includes a driving voltage input circuit 900 and a voltage-shift circuit 904. The driving voltage input circuit 900 receives a scan input voltage from a power source so as to output a predetermined scan driving voltage. The voltage-shift circuit includes a plurality of sub-voltage-shift circuits 9040, 9042 and 9044. Each of the sub-voltage-shift circuits 9040, 9042 and 9044 includes two input terminals and an output terminal. One input terminal of each of the sub-voltage-shift circuits 9040, 9042 and 9044 receives the predetermined scan driving voltage. The other input terminals of the sub-voltage-shift circuits 9040, 9042 and 9044 respectively receive a predetermined level-shift voltage V_{R}, V_{G} and V_{B} required by a row of the bistable liquid crystal cells corresponding thereto. The output terminals of the sub-voltage-shift circuits 9040, 9042 and 9044 respectively output a scan voltage through a scan line to the electrode terminals of the corresponding bistable liquid crystal cells for scan voltage input. The data voltage driving circuit 801 includes a plurality of data lines respectively provides a data input voltage to the other electrode terminals of the row of the bistable liquid crystal cells corresponding thereto for data voltage input.

While the invention has been described by way of examples and in terms of preferred embodiments, it is to be understood that various changes, substitutions, and alterations can be made herein without departing from the spirit and scope of the invention as defined by the appended claims.

What is claimed is:

1. A driving circuit capable of simultaneously driving three-color bistable liquid crystals, comprising:
a driving voltage input circuit for receiving an input voltage from the external so as to output a predetermined driving voltage; and
a voltage-shift circuit including a plurality of sub-voltage-shift circuit, wherein the predetermined driving voltage and a predetermined level-shift voltage required by a liquid crystal cell are inputted to one of said sub-voltage-shift circuit corresponding thereto via the same input terminal or different input terminals of said sub-voltage-shift circuit, and said sub-voltage-shift circuit via an output terminal thereof outputs a liquid crystal driving voltage to an electrode terminal of the liquid crystal cell.

2. The driving circuit capable of simultaneously driving three-color bistable liquid crystals of claim 1, which is served as a data voltage driving circuit of a bistable liquid crystal display device.

3. The driving circuit capable of simultaneously driving three-color bistable liquid crystals of claim 1, which is served as a scan voltage driving circuit of a passive matrix bistable liquid crystal display device.

4. The driving circuit capable of simultaneously driving three-color bistable liquid crystals of claim 1, wherein said driving voltage input circuit converts the input voltage into the predetermined driving voltage by a pulse width modulation driving method.

5. The driving circuit capable of simultaneously driving three-color bistable liquid crystals of claim 1, wherein each of said sub-voltage-shift circuits corresponding to the same color liquid crystal cells includes an operational amplifier, a first resistor, a second resistor, a third resistor and a fourth resistor, wherein an input terminal of said operational amplifier is electrically coupled to one respective terminal of said second resistor and said first resistor, and the other input terminal of said operational amplifier is electrically coupled to one respective terminal of said third resistor and said fourth resistor, an output terminal of said operational amplifier is electrically coupled to said electrode terminal of the liquid crystal cell corresponding thereto, the other terminal of said first resistor is electrically coupled to the predetermined driving voltage, the other terminal of said second resistor is electrically coupled to the predetermined level-shift voltage, the other terminae of said third resistor is grounded, and the other terminal of said fourth resistor is electrically coupled to said output terminal of said operational amplifier.

6. The driving circuit capable of simultaneously driving three-color bistable liquid crystals of claim 1, wherein each of said sub-voltage-shift circuits corresponding to the same color liquid crystal cells includes an operational amplifier, a first resistor, a second resistor, a third resistor and a fourth resistor, wherein an input terminal of said operational amplifier is electrically coupled to one respective terminal of said first resistor and said second resistor, the other input terminal of said operational amplifier is electrically coupled to one respective terminal of said third resistor and said fourth resistor, an output terminal of said operational amplifier is electrically coupled to said electrode terminal of the liquid crystal cell corresponding thereto, the other terminal of said first resistor is electrically coupled to said output terminal of said operational amplifier, the other terminal of said second resistor is electrically coupled to the predetermined driving voltage, the other terminal of said third resistor is grounded, and the other terminal of said fourth resistor is electrically coupled to the predetermined level-shift voltage.

7. The driving circuit capable of simultaneously driving three-color bistable liquid crystals of claim 1, wherein each of said sub-voltage-shift circuits corresponding to the same color liquid crystal cells includes an operational amplifier, a first resistor, a second resistor, a third resistor and a fourth resistor, wherein an input terminal of said operational amplifier is electrically coupled to the predetermined driving voltage, the other input terminal of said operational amplifier is electrically coupled to one respective terminal of said first resistor and said second resistor, an output terminal of said operational amplifier is electrically coupled to said electrode terminal of the liquid crystal cell corresponding thereto, the other terminal of said first resistor is electrically coupled to said output terminal of said operational amplifier, the other terminal of said second resistor is electrically coupled to one respective terminal of said third resistor and said fourth resistor, the other terminal of said third resistor is grounded, and the other terminal of said fourth resistor is electrically coupled to the predetermined level-shift voltage.

8. The driving circuit capable of simultaneously driving three-color bistable liquid crystals of claim 1, wherein each of said sub-voltage-shift circuits corresponding to the same color liquid crystal cells includes an operational amplifier, a first resistor, a second resistor and a third resistor, wherein an input terminal of said operational amplifier is electrically coupled to one respective terminal of said first resistor, said second resistor and said third resistor, the other input terminal of said operational amplifier is grounded, an output terminal of said operational amplifier is electrically coupled to said electrode terminal of the liquid crystal cell corresponding thereto, the other terminal of said first resistor is electrically coupled to said output terminal, the other terminal of said second resistor is electrically coupled to the predetermined driving voltage, and the other terminal of said third resistor is electrically coupled to the predetermined level-shift voltage.

9. The driving circuit capable of simultaneously driving three-color bistable liquid crystals of claim 2, wherein said driving voltage input circuit includes a data voltage driving circuit, a level shifter and a digital-to-analog converter, said data voltage driving circuit receives the input voltage in digital form, and then which is shifted to the predetermined driving voltage in digital form by said level shifter, and the predetermined driving voltage in digital form is converted to an equal value in analog form by said digital-to-analog converter.

10. A passive matrix three-color bistable liquid crystal display device, including:
a display area including plural rows of first color bistable liquid crystal cells aligned in the vertical direction, plural rows of second color bistable liquid crystal cells aligned in the vertical direction and plural rows of third color bistable liquid crystal cells aligned in the vertical direction, wherein each row of the first color liquid crystal cells includes a plurality of liquid crystal cells, each row of the second color liquid crystal cells includes a plurality of liquid crystal cells and each row of the third color liquid crystal cells includes a plurality of liquid crystal cells, and the first color liquid crystal cells, the second color liquid crystal cells and the third color liquid crystal cells are inter-disposed to each other in the parallel direction;
a scan voltage driving circuit including a plurality of scan lines sequentially and respectively providing a scan voltage to the liquid crystal cells corresponding thereto; and
a data voltage driving circuit with level-shift voltage including a driving voltage input circuit and a voltage-shift circuit, wherein said driving voltage input circuit receives an input voltage from the external so as to output a predetermined driving voltage, said voltage-shift circuit includes a plurality of sub-voltage-shift circuit, the predetermined driving voltage and a predetermined level-shift voltage required by a liquid crystal cell are inputted to one of said sub-voltage-shift circuit corresponding thereto via the same input terminal or different input terminals of said sub-voltage-shift circuit, and said sub-voltage-shift circuit via an output terminal thereof outputs a liquid crystal driving voltage to an electrode terminal of the liquid crystal cell.

11. The passive matrix three-color bistable liquid crystal display device of claim 10, wherein said driving voltage input circuit converts the input voltage into the predetermined driving voltage by a pulse width modulation driving method.

12. The passive matrix three-color bistable liquid crystal display device of claim 10, wherein each of said sub-voltage-shift circuits corresponding to the same color liquid crystal cells includes an operational amplifier, a first resistor, a second resistor, a third resistor and a fourth resistor, wherein an input terminal of said operational amplifier is electrically coupled to one respective terminal of said second resistor and said first resistor, and the other input terminal of said operational amplifier is electrically coupled to one respective terminal of said third resistor and said fourth resistor, an output terminal of said operational amplifier is electrically coupled to said electrode terminal of the liquid crystal cell corresponding thereto, the other terminal of said first resistor is electrically coupled to the predetermined driving voltage, the other terminal of said second resistor is electrically coupled to the predetermined level-shift voltage, the other terminal of said third resistor is grounded, and the other terminal of said fourth resistor is electrically coupled to said output terminal of said operational amplifier.

13. The passive matrix three-color bistable liquid crystal display device of claim 10, wherein each of said sub-voltage-shift circuits corresponding to the same color liquid crystal cells includes an operational amplifier, a first resistor, a second resistor, a third resistor and a fourth resistor, wherein an input terminal of said operational amplifier is electrically coupled to one respective terminal of said first resistor and said second resistor, the other input terminal of said operational amplifier is electrically coupled to one respective terminal of said third resistor and said fourth resistor, an output terminal of said operational amplifier is electrically coupled to said electrode terminal of the liquid crystal cell corresponding thereto, the other terminal of said first resistor is electrically coupled to said output terminal of said operational amplifier, the other terminal of said second resistor is electrically coupled to the predetermined driving voltage, the other terminal of said third resistor is grounded, and the other terminal of said fourth resistor is electrically coupled to the predetermined level-shift voltage.

14. The passive matrix three-color bistable liquid crystal display device of claim 10, wherein each of said sub-voltage-shift circuits corresponding to the same color liquid crystal cells includes an operational amplifier, a first resistor, a second resistor, a third resistor and a fourth resistor, wherein an input terminal of said operational amplifier is electrically coupled to the predetermined driving voltage, the other input terminal of said operational amplifier is electrically coupled to one respective terminal of said first resistor and said second resistor, an output terminal of said operational amplifier is electrically coupled to said electrode terminal of the liquid crystal cell corresponding thereto, the other terminal of said first resistor is electrically coupled to said output terminal of said operational amplifier, the other terminal of said second resistor is electrically coupled to one respective terminal of said third resistor and said fourth resistor, the other terminal of said third resistor is grounded, and the other terminal of said fourth resistor is electrically coupled to the predetermined level-shift voltage.

15. The passive matrix three-color bistable liquid crystal display device of claim 10, wherein each of said sub-voltage-shift circuits corresponding to the same color liquid crystal cells includes an operational amplifier, a first resistor, a second resistor and a third resistor, wherein an input terminal of said operational amplifier is electrically coupled to one respective terminal of said first resistor, said second resistor and said third resistor, the other terminal of said operational amplifier is grounded, an output terminal of said operational amplifier is electrically coupled to said electrode terminal of the liquid crystal cell corresponding thereto, the other terminal of said first resistor is electrically coupled to said output terminal, the other terminal of said second resistor is electrically coupled to the predetermined driving voltage, and the other terminal of said third resistor is electrically coupled to the predetermined level-shift voltage.

16. A passive matrix three-color bistable liquid crystal display device, including:
a display area including plural rows of first color bistable liquid crystal cells aligned in the parallel direction, plural rows of second color bistable liquid crystal cells aligned in the parallel direction and plural rows of third color bistable liquid crystal cells aligned in the parallel direction, wherein each row of the first color liquid crystal cells includes a plurality of liquid crystal cells, each row of the second color liquid crystal cells includes a plurality of liquid crystal cells and each row of the third color liquid crystal cells includes a plurality of liquid crystal cells, and the first color liquid crystal cells, the second color liquid crystal cells and the third color liquid crystal cells are inter-disposed to each other in the vertical direction;
a scan voltage driving circuit with level-shift voltage including a plurality of scan lines sequentially and respectively providing a scan voltage to the liquid crystal cells corresponding thereto, wherein said scan voltage driving circuit including a driving voltage input circuit and a voltage-shift circuit, said driving voltage input circuit receives an input voltage from the external so as to output a predetermined driving voltage, said voltage-shift circuit includes a plurality of sub-voltage-shift circuit, the predetermined driving voltage and a predetermined level-shift voltage required by a liquid crystal cell are inputted to one of said sub-voltage-shift circuit corresponding thereto via the same input terminal or different input terminals of said sub-voltage-shift circuit, and said sub-voltage-shift circuit via an output terminal thereof outputs a scan voltage to an electrode terminal of one row of the liquid crystal cells corresponding thereto through one of the scan lines corresponding thereto; and
a data voltage driving circuit including a plurality of data lines respectively providing a data voltage to the row of liquid crystal cells corresponding thereto.

17. The passive matrix three-color bistable liquid crystal display device of claim 16, wherein said driving voltage input circuit converts the input voltage into the predetermined driving voltage by a pulse width modulation driving method.

18. The passive matrix three-color bistable liquid crystal display device of claim 16, wherein each of said sub-voltage-shift circuits corresponding to the scan lines of the same color liquid crystal cells includes an operational amplifier, a first resistor, a second resistor, a third resistor and a fourth resistor, wherein an input terminal of said operational amplifier is electrically coupled to one respective terminal of said second resistor and said first resistor, and the other input terminal of said operational amplifier is electrically coupled to one respective terminal of said third resistor and said fourth resistor, an output terminal of said operational amplifier is electrically coupled to one of the scan lines corresponding thereto, the other terminal of said first resistor is electrically coupled to the predetermined driving voltage, the other terminal of said second resistor is electrically coupled to the predetermined level-shift voltage, the other terminal of said third resistor is grounded, and the other terminal of said fourth resistor is electrically coupled to said output terminal of said operational amplifier.

19. The passive matrix three-color bistable liquid crystal display device of claim 16, wherein each of said sub-voltage-shift circuits corresponding to the scan lines of the same color liquid crystal cells includes an operational amplifier, a first resistor, a second resistor, a third resistor and a fourth resistor, wherein an input terminal of said operational amplifier is electrically coupled to one respective terminal of said first resistor and said second resistor, the other input terminal of said operational amplifier is electrically coupled to one respective terminal of said third resistor and said fourth resistor, an output terminal of said operational amplifier is electrically coupled to one of the scan lines corresponding thereto, the other terminal of said first resistor is electrically coupled to said output terminal of said operational amplifier, the other terminal of said second resistor is electrically coupled to the predetermined driving voltage, the other terminal of said third resistor is grounded, and the other terminal of said fourth resistor is electrically coupled to the predetermined level-shift voltage.

20. The passive matrix three-color bistable liquid crystal display device of claim 16, wherein each of said sub-voltage-shift circuits corresponding to the scan lines of the same color liquid crystal cells includes an operational amplifier, a first resistor, a second resistor, a third resistor and a fourth resistor, wherein an input terminal of said operational amplifier is electrically coupled to the predetermined driving voltage, the other input terminal of said operational amplifier is electrically coupled to one respective terminal of said first resistor and said second resistor, an output terminal of said operational amplifier is electrically coupled to one of the scan lines corresponding thereto, the other terminal of said first resistor is electrically coupled to said output terminal of said operational amplifier, the other terminal of said second resistor is electrically coupled to one respective terminal of said third resistor and said fourth resistor, the other terminal of said third resistor is grounded, and the other terminal of said fourth resistor is electrically coupled to the predetermined level-shift voltage.

21. The passive matrix three-color bistable liquid crystal display device of claim 16, wherein each of said sub-voltage-shift circuits corresponding to the scan lines of the same color liquid crystal cells includes an operational amplifier, a first resistor, a second resistor and a third resistor, wherein an input terminal of said operational amplifier is electrically coupled to one respective terminal of said first resistor, said second resistor and said third resistor, the other input terminal of said operational amplifier is grounded, an output terminal of said operational amplifier is electrically coupled to one of the scan lines corresponding thereto, the other terminal of said first resistor is electrically coupled to said output terminal, the other terminal of said second resistor is electrically coupled to the predetermined driving voltage, and the other terminal of said third resistor is electrically coupled to the predetermined level-shift voltage.

22. An active matrix three-color bistable liquid crystal display device, including:
a display area including plural rows of first color bistable liquid crystal cells aligned in the vertical direction, plural rows of second color bistable liquid crystal cells aligned in the vertical direction and plural rows of third color bistable liquid crystal cells aligned in the vertical direction, wherein each row of the first color liquid crystal cells includes a plurality of liquid crystal cells, each row of the second color liquid crystal cells includes a plurality of liquid crystal cells and each row of the third color liquid crystal cells includes a plurality of liquid crystal cells, and the first color liquid crystal cells, the second color liquid crystal cells and the third color liquid crystal cells are inter-disposed to each other in the parallel direction;
a scan voltage driving circuit including a plurality of scan lines sequentially and respectively providing a scan voltage to the liquid crystal cells corresponding thereto; and
a data voltage driving circuit with level-shift voltage including a driving voltage input circuit and a voltage-shift circuit, wherein said driving voltage input circuit receives an input voltage from the external so as to output a predetermined driving voltage, said voltage-shift circuit includes a plurality of sub-voltage-shift circuit, the predetermined driving voltage and a predetermined level-shift voltage required by a liquid crystal cell are inputted to one of said sub-voltage-shift circuit corresponding thereto via the same input terminal or different input terminals of said sub-voltage-shift circuit, and said sub-voltage-shift circuit via an output terminal thereof outputs a liquid crystal driving voltage to an electrode terminal of the liquid crystal cell with the other electrode terminal thereof electrically coupled to a lower voltage source.

23. The active matrix three-color bistable liquid crystal display device of claim 22, wherein said driving voltage input circuit converts the input voltage into the predetermined driving voltage by a pulse width modulation driving method.

24. The active matrix three-color bistable liquid crystal display device of claim 22, wherein each of said sub-voltage-shift circuits corresponding to the same color liquid crystal cells includes an operational amplifier, a first resistor, a second resistor, a third resistor and a fourth resistor, wherein an input terminal of said operational amplifier is electrically coupled to one respective terminal of said second resistor and said first resistor, and the other input terminal of said operational amplifier is electrically coupled to one respective terminal of said third resistor and said fourth resistor, an output terminal of said operational amplifier is electrically coupled to said electrode terminal of the liquid crystal cell corresponding thereto, the other terminal of said first resistor is electrically coupled to the predetermined driving voltage, the other terminal of said second resistor is electrically coupled to the predetermined level-shift voltage, the other terminal of said third resistor is grounded, and the other terminal of said fourth resistor is electrically coupled to said output terminal of said operational amplifier.

25. The active matrix three-color bistable liquid crystal display device of claim 22, wherein each of said sub-voltage-shift circuits corresponding to the same color liquid crystal cells includes an operational amplifier, a first resistor, a second resistor, a third resistor and a fourth resistor, wherein an input terminal of said operational amplifier is electrically coupled to one respective terminal of said first resistor and said second resistor, the other input terminal of said operational amplifier is electrically coupled to one respective terminal of said third resistor and said fourth resistor, an output terminal of said operational amplifier is electrically coupled to said electrode terminal of the liquid crystal cell corresponding thereto, the other terminal of said first resistor is electrically coupled to said output terminal of said operational amplifier, the other terminal of said second resistor is electrically coupled to the predetermined driving voltage, the other terminal of said third resistor is grounded, and the other terminal of said fourth resistor is electrically coupled to the predetermined level-shift voltage.

26. The active matrix three-color bistable liquid crystal display device of claim 22, wherein each of said sub-voltage-shift circuits corresponding to the same color liquid crystal cells includes an operational amplifier, a first resistor, a second resistor, a third resistor and a fourth resistor, wherein an input terminal of said operational amplifier is electrically coupled to the predetermined driving voltage, the other input terminal of said operational amplifier is electrically coupled to one respective terminal of said first resistor and said second resistor, an output terminal of said operational amplifier is electrically coupled to said electrode terminal of the liquid crystal cell corresponding thereto, the other terminal of said first resistor is electrically coupled to said output terminal of said operational amplifier, the other terminal of said second resistor is electrically coupled to one respective terminal of said third resistor and said fourth resistor, the other terminal of said third resistor is grounded, and the other terminal of said fourth resistor is electrically coupled to the predetermined level-shift voltage.

27. The active matrix three-color bistable liquid crystal display device of claim 22, wherein each of said sub-voltage-shift circuits corresponding to the same color liquid crystal cells includes an operational amplifier, a first resistor, a second resistor and a third resistor, wherein an input terminal of said operational amplifier is electrically coupled to one respective terminal of said first resistor, said second resistor and said third resistor, the other input terminal of said operational amplifier is grounded, an output terminal of said operational amplifier is electrically coupled to said electrode terminal of the liquid crystal cell corresponding thereto, the other terminal of said first resistor is electrically coupled to said output terminal, the other terminal of said second resistor is electrically coupled to the predetermined driving voltage, and the other terminal of said third resistor is electrically coupled to the predetermined level-shift voltage.
